(19) United States
(12) Patent Application Publication
(10) Pub. No.: US 2024/0054630 A1
(43) Pub. Date: Feb. 15, 2024

(54) SYSTEMS AND METHODS FOR MONITORING SAFETY IN BUILDINGS

(71) Applicant: INDOOR ROBOTICS LTD., RAMAT-GAN (IL)

(72) Inventors: AMIT MORAN, TEL-AVIV (IL); OFIR BAR LEVAV, TEL-AVIV (IL); DORON BEN-DAVID, PETACH TIKVA (IL)

(21) Appl. No.: 17/884,592

(22) Filed: Aug. 10, 2022

(51) Int. Cl. G06T 7/00; G06T 7/70; G06V 10/62; B64C 39/02

(52) U.S. Cl. CPC G06T 7/0006; G06T 7/70; G06V 10/62; B64C 39/024; G06T 2207/10032; G06V 2201/10; B64C 2201/127; B64C 2201/141

(57) ABSTRACT

Monitoring a storage system for placing physical goods in an indoor environment using an aerial vehicle by receiving a command to check a status of the storage system, moving towards a storage system based on the command, capturing an image of the storage system using a sensor carried by the aerial device, analyzing the captured image to identify irregularities in a structure or position of the storage system, and reporting irregularities of the storage system to a third party.

### FIELD AND BACKGROUND

The invention, in some embodiments thereof, relates to monitoring the safety of equipment in buildings, for example specifically cabinets and shelves.

Currently, when monitoring such equipment, persons, for example, employees, look at the equipment from time to time, trying to see if there are any hazardous situations in the equipment, which may result in accidents, physical damages, financial damages, increase in insurance costs and additional challenges.

### SUMMARY

In one aspect of the invention a method is provided for monitoring a storage system for placing physical goods in an indoor environment using an aerial vehicle, the method including receiving a command to check a status of the storage system, moving towards a storage system based on the command, capturing an image of the storage system using a sensor carried by the aerial device, analyzing the captured image to identify irregularities in a structure or position of the storage system, reporting irregularities of the storage system to a third party.

In some cases, the method further comprises comparing the image to a bank of storage system's irregularities to identify a specific irregularity from multiple optional irregularities, wherein reporting the irregularities to a third party comprises identifying the specific irregularity.

In some cases, the method further comprises receiving metadata of a specific storage system and capturing an image of the specific storage system based on the metadata. In some cases, the method further comprises computing an importance level of the storage system based on the metadata.

In some cases, the method further comprises computing a monitoring frequency for monitoring a specific storage system based on the importance level of the storage system. In some cases, the method further comprises storing time stamps for the image.

In some cases, the method further comprises storing location coordinates and azimuth of the aerial vehicle when storing the image and sending the aerial vehicle to the location coordinates when capturing a subsequent image of the same storage system.

In some cases, the method further comprises identifying a trend in the storage system's position based on a comparison of multiple images of the storage system, wherein the multiple images are taken in a time difference higher than a threshold.

In some cases, the method further comprises comparing the captured image of other images of the storage system, wherein the other images of the storage system are taken in a time difference higher than a threshold prior to capturing the image. In some cases, the method further comprises identifying features from the images that indicate irregularities in the storage system's structure.

In some cases, the command is received according to a set of rules stored in the aerial vehicle. In some cases, the command is received from a remote device communicating with the aerial vehicle. In some cases, the command comprises coordinates of the storage system.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows multiple shelves for carrying and storing goods, in accordance with some embodiments of the invention;

FIG. 2 shows a method for monitoring shelves' irregularities, in accordance with some embodiments of the invention;

FIG. 3 shows a method for analyzing images that show shelves when monitoring shelves' irregularities, in accordance with some embodiments of the invention;

FIG. 4 shows an aerial vehicle for monitoring shelves' irregularities, in accordance with some embodiments of the invention.

### DETAILED DESCRIPTION

The invention, in some embodiments thereof, relates to monitoring the safety of storage systems used to store goods, for example, shelves and cabinets, for example in warehouses or other structures, such as residential buildings, offices, and the like. For simplicity, many examples below refer to shelves, but the invention, in some embodiments thereof, encompasses every structure or surface other than the floor/ground used to carry, place or store goods. The storage system may be a single shelf, multiple shelves, a cabinet, a mechanism coupled to a shelf, a screw, a nail, and other objects used to affix shelves or cabinets to other the ground, ceiling, and walls. The invention, in some embodiments thereof, may prevent the goods from falling from the shelves, cause physical injuries to persons, or vehicles, or just require additional labor time to bring the goods back into place. The shelves, surfaces, cabinets or any other structure commonly used to carry goods may be damaged and collapse also when not carrying goods.

The invention, in some embodiments thereof, identifies irregularities in the shelves. The irregularities may be defined as a change in the shelves' angle relative to the ground, ceiling, or any other reference plane, for example when the angle is larger than 3 degrees. The irregularities may be defined as an insecure position of the shelves, for example, the shelves' location relative to the poles. The irregularities may be defined as an insecure connection between the shelves and the poles or to another object configured to secure the shelves. The irregularities may be defined as an insecure or irregular position or location of a mechanism used to secure the shelves into place, said mechanism may be a pin, a screw and the like, The irregularities may also be defined as dents in the shelf, bends in the shelf, and other irregular forms or shapes of the shelf compared to a bank of regular or standard shelves' shapes and forms.

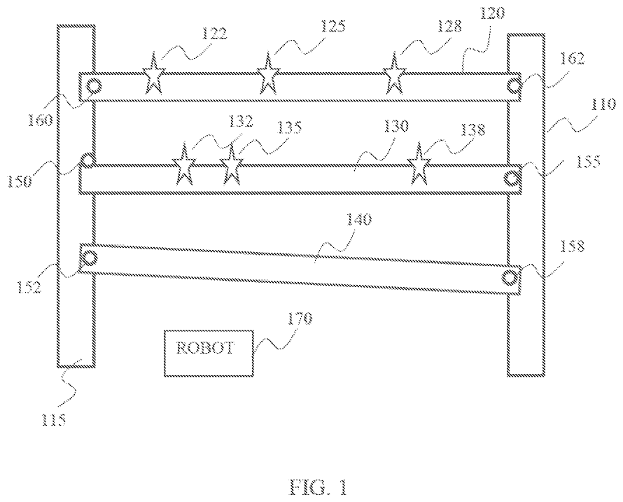

FIG. 1 shows multiple shelves for carrying and storing goods, in accordance with some embodiments of the invention. The shelves 120, 130, 140, are likely to be substantially parallel to the ground. The distance between the shelves 120, 130, 140 may vary and may be adjusted when coupling the shelves 120, 130, 140 to poles 110, 115. The shelves 120, 130, 140 may be coupled to walls, or to other structures, the walls/poles/structures may be coupled to the ground or to a base of the warehouse in which the shelves 120, 130, 140 are located.

The shelves 120, 130, 140 may be coupled to the poles 110, 115 using screws. For example, shelf 120 is coupled to pole 110 using screw 162, shelf 120 is coupled to pole 115 using screw 162, shelf 130 is coupled to pole 110 using screw 155, shelf 130 is coupled to pole 115 using screw 150, shelf 140 is coupled to pole 110 using screw 158, shelf 140 is coupled to pole 115 using screw 152.

The shelves 120, 130, 140 may be of an open configuration, enabling free access to the goods placed on the shelves 120, 130, 140. The shelves 120, 130, 140 may be of a close configuration, limiting access to the goods, for example via doors or grates. The type, size and number of goods or packages placed on the shelves may vary according to the shelves' size, structure, and other properties. For example, shelf 120 carries goods 122, 125 and 128, shelf 130 carries goods 132, 135 and 138 and shelf 140 does not carry any goods. The goods may be any kind of items which is normally stored on shelves or cabinets, such as food items, clothes, electronic devices, books, pharmaceutical objects, cosmetics, and the like. The goods may be packaged or be placed on the shelves in their normal forms, such as a package of 20 toothbrushes or a non-packaged book.

Aerial vehicle 170 moves around the warehouse looking for irregularities in the shelves. The warehouse may contain thousands of shelves, or even millions, the shelves may have an identifier in a database configured to assist the aerial vehicle 170 to monitor the shelves' status. When monitoring shelves 120, 130, 140, the aerial vehicle 170 moves closer to the area of the shelves and capture images of the shelves. In some cases, the images may be taken separately for each shelf or for sub-groups of shelves, such as 3 shelves maximum.

Analysis of the captured image may be done by the aerial vehicle 170 or by a remote device, such as a server or laptop coupled to a docking station of the aerial vehicle. Analysis of the images may identify that shelf 140 is in an irregular position, as one side of the shelf is lower than the other side in a value higher than a threshold. The analysis may also identify that screw 150 is out of place, meaning that the shelf 130 is improperly coupled to the pole 115.

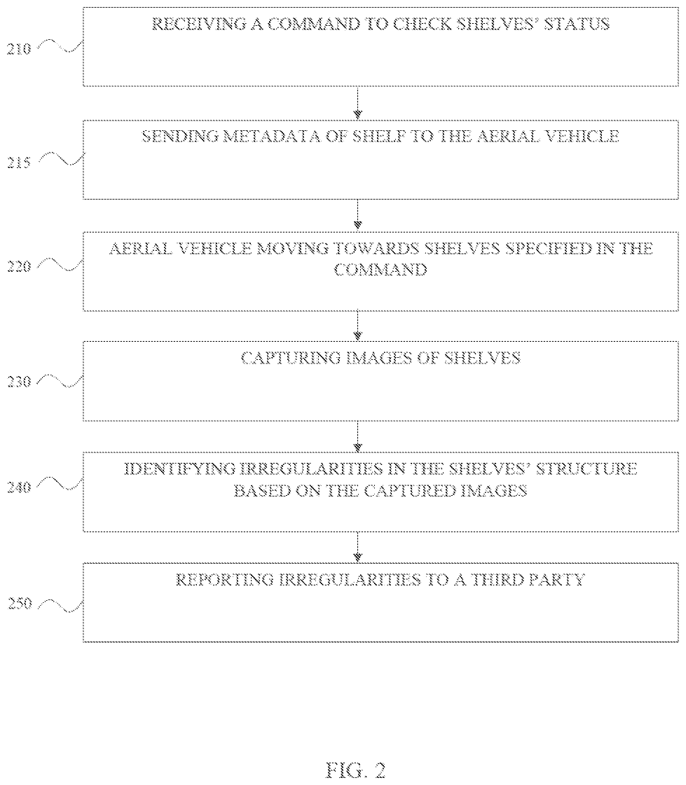

FIG. 2 shows a method for monitoring shelves' irregularities, in accordance with some embodiments of the invention. The method may be performed by a single aerial vehicle or using multiple aerial vehicles configured to monitor the same area or the same storage system. The multiple aerial vehicles may capture images of the same storage system from different angles or directions, enabling to create a three-dimensional image, or enabling to identify irregularities from additional aspects. The multiple aerial vehicles may have multiple types of sensors, for example a first aerial vehicle with an IR camera and a second first aerial vehicle with a radar.

At 210, the method discloses receiving a command to check shelves' status. The command may include an identifier of a specific shelf, multiple shelves, an area to be monitored and the like. For example, a command may be “move to isle #4, monitor all shelves between first ten poles”. The command may be initiated from the aerial vehicle based on a set of rules, for example “monitor all shelves once every 45 minutes”, or monitor all the shelves in area #1 once every 3 hours and all the shelves in area #2 once every 2 weeks”. The command may be initiated based on data collected by an environmental sensor, for example, irregular level of noise, leakage of gas, amount of light that is higher or lower than a threshold, and the like. The command may be received at a communication unit of the aerial vehicle, such as a wireless transceiver, or be copied into a memory address of the aerial vehicle.

At 215, the method discloses sending metadata of shelf to the aerial vehicle. The metadata may include the shelf's location, an identifier of the shelf in a database, the shelf's size, type of goods carried by the shelf, sensitivity level of the goods carried by the shelf and the like. In some cases, the method comprises computing an importance level of the shelf based on the metadata. In some cases, the method comprises computing a monitoring frequency for monitoring a specific shelf based on the importance level of the shelf. The monitoring frequency may be once every 5 minutes, once a day, once every 4 hours and the like.

At 220, the method discloses the aerial vehicle moving toward the shelves specified in the command. The aerial vehicle may fly towards the shelf appearing in the command. In some cases, the aerial vehicle may be required to capture images of multiple shelves and create an optimal path among the multiple shelves from the docking station and back to the docking station after capturing the images of all the shelves in the command.

At 230, the method discloses capturing images of shelves. In some cases, the images may include a single shelf, multiple shelves or a combination of both. The images may be stored with metadata that enables to identify the shelves, for example the aerial vehicle's location, height and the camera's heading or azimuth when capturing the image. The captured images may be stored in a memory storage of the aerial vehicle. The captured images may be sent to a third party for analysis. The quality of the image, for example a resolution, or the distance between a specific shelf and the aerial vehicle may be determined based on the importance level of the specific shelf.

The captured images may be captured using an image sensor, or via other types of sensors that can be used to create images, such as laser scan, depth images, radar, sonar and the like.

At 240, the method discloses identifying irregularities in the shelves' structure based on the captured images. The irregularities may relate to the shelves, to the poles holding the shelves, to goods carried by the shelves, to mechanisms coupling the shelves to the poles. The irregularities are identified based on the captured images, for example by comparing different images of the same shelf captured in different days, identifying irregular shapes or positions of the shelves and the like.

In some exemplary cases, the shelves may be equipped with an identifier, for example a strip having a specific color or property, and the analysis comprises identifying the identifier in the captured image and detecting the irregularity based on the identifier.

In some cases, the irregularities comprise identifying an empty space in the shelf, or an empty space which is higher than a trigger threshold. For example, an empty space of less than 50 square centimeters does not count as irregularity. An irregularity may be defined as change in a shelf's capacity between subsequent images of the shelf. For example, a first image captured at 10:00 identified that the shelf contains 12 packages and a second image captured at 10:05 identified that the shelf contains 8 packages. The irregularity in the difference between the subsequent images may be associated with a rate of delivering packages from the warehouse.

In some cases, the irregularities may comprise identifying objects protruding from the shelf. Protrusion may be defined as objects placed more than 0.5 centimeters ahead of the shelf's front surface, assuming that the shelf has a top surface on which the goods are placed and a front surface that points towards the general location from which the goods are loaded onto the shelf.

In some cases, the irregularities may comprise affixing issues. For example, screws or pins which are out of place, such as screw 150 of FIG. 1. Other irregularities associated with affixing issues may include lack of affixing elements, identifying affixing elements that do not match the shelf, the shelf's size or the shelf's type, and the like.

In some cases, the irregularities may comprise deformation of the shelf. Deformation may include change in the shelf's form, for example due to wetness, humidity or being hit by another object. The deformation may be identified by comparing subsequent images of the shelf or by comparing an image of the shelf to standard shelf's forms in a database.

At 250, the method discloses reporting irregularities to a third party. the third party may be a server, or a device held by a person in charge of fixing the shelves. The report may include a location of the shelf having the irregularity in the shelves' structure.

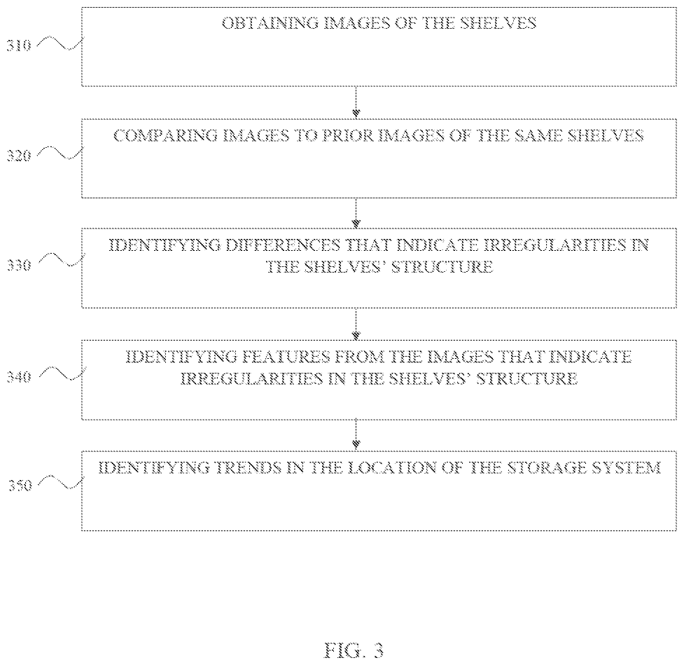

FIG. 3 shows a method for analyzing images that show shelves when monitoring shelves' irregularities, in accordance with some embodiments of the invention.

At 310, the method discloses obtaining images of the shelves. At least a portion of the images may be captured by the aerial vehicle. Some of the images may be provided from a bank of shelves' images, for example in order to train a machine learning model to identify irregularities in shelves' structure. The images may be stored as associated with metadata, such as a timestamp, location or coordinates of the aerial vehicle when capturing the image, shelf identifier and the like.

At 320, the method discloses comparing images to prior images of the same shelves. comparing may comprise a step of matching resolutions or size of both images. Comparing may be done on an area-to-area basis. The comparison may be done only on an area identified as the shelf's area. The comparison may be done by a software model, a server, the aerial device, or another machine. The comparison may be done only in case the timestamp of the images differs by a value higher than a threshold, for example in the case at least 90 minutes elapsed between the timestamps representing the time in which the images were captured.

At 330, the method discloses identifying differences between images of the shelf that indicate irregularities in the shelf's structure. The differences may be different positions of the shelf, for example, relative to the ground or to poles that carry the shelf. The differences may be of the mechanism holding the shelf.

At 340, the method discloses identifying features from the images that indicate irregularities in the shelves' structure or position. The features may be an angle of the shelves relative to the ground. The features may be stored in a memory storage, for example as images or filters representing shapes or positions of shelves. A software model may be used to identify the features stored in the memory with the captured image.

At 350, the method discloses identifying trends in the location of the storage system. The trends may be defined as gradual changes in the location of the shelf over time. The trends may be defined as gradual changes in the position of the shelf over time. The trends may be defined as gradual changes in the position of the mechanisms coupled to the shelf over time.

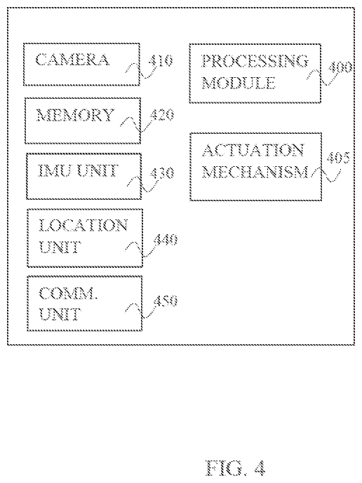

FIG. 4 shows an aerial vehicle for monitoring shelves' irregularities, in accordance with some embodiments of the invention.

The aerial vehicle comprises a processing module 400 configured to process the aerial device's missions, and other actions performed by the aerial vehicle Thus, the processing module 400 is coupled to the actuation mechanism 405 configured to move the aerial vehicle. Such coupling may be via an electrical channel or cable, wireless communication, magnetic-based communication, optical fibers and the like. The processing module 400 may send a command to the actuation mechanism 405 to move to a certain location associated with a shelf. The command may include instructions as to how to move to the certain location. The processing module 400 as defined herein may be a processor, controller, microcontroller and the like.

The aerial vehicle comprises an actuation mechanism 405 for moving the aerial vehicle from one place to another. The actuation mechanism 405 may comprise a motor, an actuator and any mechanism configured to maneuver a physical member. The actuation mechanism 405 may comprise a rotor of some sort, or another mechanism enabling the aerial vehicle to fly. The actuation mechanism 405 is coupled to a power source, such as a battery or a renewable energy member, such as a solar panel in case the area comprises or is adjacent to an outdoor area accessible to the mobile robot 200. The actuation mechanism 230 may move the mobile robot 200 in two or three dimensions.

The aerial vehicle comprises a camera unit 410 including one or more cameras for capturing images and/or videos. The cameras of the camera unit 410 may be mechanically coupled to arms or other tilting mechanisms for changing the position of one or more of the cameras relative to the heading of the aerial vehicle. The processing module 400 may control the properties of the images captured by the cameras, such as size, resolution, grayscale or RGB and the like.

The aerial vehicle comprises a memory 420 for storing instructions and data collected by the sensors of the aerial vehicle.

The aerial vehicle comprises an inertial measurement unit (IMU) 430 configured to measure the robot's linear acceleration and angular velocities. The measurements collected by the IMU 430 may be transmitted to the processing module 400 configured to process the measurements. The IMU 430 may comprise one or more sensors, such as an accelerator, a gyroscope, a compass or magnetometer, a barometer and any the like.

The aerial vehicle comprises a Location unit 440 configured to locate the aerial vehicle's location. The location unit 440 may include a GPS receiver, wireless receiver that enable triangulation technique to locate the aerial vehicle, other sensors used to locate the aerial vehicle and additional techniques desired by a person skilled in the art.

The aerial vehicle may also comprise communication unit 450 via which the commands are received at the aerial vehicle. The communication module 450 may be configured to receive wireless signals, such as RF, Bluetooth, Wi-Fi and the like. In some other cases, the commands may be initiated from a set of rules stored in the memory of the aerial vehicle, or in the docking station to which the aerial vehicle is secured to be electrically charged, to exchange information faster, and the like. The images, or conclusions processed from the images and performed on the aerial vehicle, can be downloaded from the aerial vehicle via a data cable.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the invention.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the invention. To the extent that section headings are used, they should not be construed as necessarily limiting. In addition, any priority document(s) of this application is/are hereby incorporated herein by reference in its/their entirety.

What is claimed is:

1. A method for monitoring a storage system for placing physical goods in an indoor environment using an aerial vehicle, the method comprising:
receiving a command to check a status of the storage system;
moving towards a storage system based on the command;
capturing an image of the storage system using a sensor carried by the aerial device;
analyzing the captured image to identify irregularities in a structure or position of the storage system; and
reporting irregularities of the storage system to a third party.

2. The method of claim 1, further comprising comparing the image to a bank of storage system's irregularities to identify a specific irregularity from multiple optional irregularities, wherein reporting the irregularities to a third party comprises identifying the specific irregularity.

3. The method of claim 1, further comprising receiving metadata of a specific storage system and capturing an image of the specific storage system based on the metadata.

4. The method of claim 3, further comprising computing an importance level of the storage system based on the metadata.

5. The method of claim 4, further comprising computing a monitoring frequency for monitoring a specific storage system based on the importance level of the storage system.

6. The method of claim 1, further comprising storing time stamps for the image.

7. The method of claim 1, further comprising storing location coordinates and azimuth of the aerial vehicle when storing the image and sending the aerial vehicle to the location coordinates when capturing a subsequent image of the same storage system.

8. The method of claim 1, further comprising identifying a trend in the storage system's position based on a comparison of multiple images of the storage system, wherein the multiple images are taken in a time difference higher than a threshold.

9. The method of claim 1, further comprising comparing the captured image of other images of the storage system, wherein the other images of the storage system are taken in a time difference higher than a threshold prior to capturing the image.

10. The method of claim 1, further comprising identifying features from the images that indicate irregularities in the storage system's structure.

11. The method of claim 1, wherein the command is received according to a set of rules stored in the aerial vehicle.

12. The method of claim 1, wherein the command is received from a remote device communicating with the aerial vehicle.

13. The method of claim 1, wherein the command comprises coordinates of the storage system.
